(19) United States
(12) Patent Application Publication
(10) Pub. No.: US 2024/0005099 A1
(43) Pub. Date: Jan. 4, 2024

(54) INTEGRATED SYNTHETIC LABELING OPTIMIZATION FOR MACHINE LEARNING

(71) Applicant: PayPal, Inc., San Jose, CA (US)

(72) Inventors: Alon Dourban, Tel Aviv (IL); Roy Lothan, Tel Aviv (IL); Myriam Lesmy, Jerusalem (IL); Maya Cohen, Haifa (IL); Itay Margolin, Pardesiya (IL)

(21) Appl. No.: 17/810,123

(22) Filed: Jun. 30, 2022

(51) Int. Cl. G06F 40/30; G06N 5/02; G06F 40/279

(52) U.S. Cl. CPC G06F 40/30; G06N 5/022; G06F 40/279

(57) ABSTRACT

Techniques are disclosed relating to weakly supervised machine learning, which may be employed when there is a limited amount of labeled data available. A computer system may generate respective sets of synthetic labels for unlabeled data for a classification problem, where a given set of synthetic labels is produced by a corresponding one of a plurality of different label models. The computer system may then fit a set of supervised models, where each supervised model is fitted with one of the respective sets of synthetic labels to produce a respective set of predictions. The computer system may then evaluate the set of supervised models based on their respective set of predictions and using a set of labeled data for the classification problem. The evaluation may be used to select a particular supervised model and its corresponding label model.

### BACKGROUND

### Technical Field

This disclosure relates generally to machine learning, and, more specifically, to an approach to facilitate weak supervision of machine learning.

### Description of the Related Art

Data is a key resource for organizations that seek to deploy data-driven decisions and solutions. Today, automated solutions that are based on big data are commonly used in every industry and domain. The most popular tasks are classification and regression problems. In both cases, the solution is required to predict the value of an unknown data point, by learning a mathematical function that is based on historical data of independent variables (features) and a dependent variable (label). An approach in which an algorithm is trained on accurately labeled data is referred to as supervised learning.

Obtaining data points to be used as features is often relatively easy, as an enormous amount of data is collected and stored in databases every day. But acquiring accurately labeled data—the “ground truth” categorizing historical instances of the problem to be solved—can frequently be challenging as it might be a very scarce resource. Common ways to obtain labeled data are from historical operational data (for example, historical loss derived from transactions), or manual labelling that varies from easy mass tasks (for example, image recognition of animals) to expert analysis (for example, a doctor's assessment of previous patients). Labeling large-scale data accurately is very expensive and time-consuming and is often the bottleneck in supervised learning projects. Hence, it is not surprising that many problems that require a supervised-learning approach are faced with a limited amount of labeled data, if any.

### BRIEF DESCRIPTION OF THE DRAWINGS

FIG. 1 is a flow diagram illustrating one embodiment of a method for weakly supervised machine learning.

FIG. 2A lists one example of a set of heuristics for a text classification problem.

FIG. 2B is a table illustrating sample predictions of a label model utilizing all of the heuristics listed in FIG. 2A.

FIG. 2C is a table illustrating sample value of terms within a word embedding space.

FIG. 3 is a block diagram illustrating one embodiment of a weakly supervised machine learning approach in which various supervised models are fit using synthetic labels generated by different label models.

FIG. 4 is a table illustrating sample predictions of supervised models depicted in FIG. 3.

FIGS. 5-7 are flow diagrams illustrating example method of weakly supervised machine learning, according to some embodiments.

### DETAILED DESCRIPTION

Multiple types of algorithms exist to deal with situations in which no labels or a very limited number of labeled samples are available. One such approach is unsupervised learning, a family of algorithms that can learn to recognize patterns in unlabeled data on their own. The most popular tasks for using unsupervised learning algorithms are clustering (e.g., splitting data into distinct groups) and anomaly detection (e.g., identifying fraudulent transactions or outliers). These approaches are very helpful for finding underlying patterns in the data, particularly when there is no available tagged dataset (e.g., in the case of a new product). But since the data is unlabeled and the ground truth is unknown, it makes it difficult to determine the accuracy of the output of the algorithm, because the tag cannot be compared to the predicted output). Unsupervised algorithms are usually more time- and CPU-intensive.

Weak supervision is a family of approaches that deal with scenarios with sub-standard labels. The labels may be incomplete, where a subset of samples is labeled with reliable and accurate labels, while the complementary subset is not labeled. The labels might also be inexact. They might be provided at a higher-level of granularity than would be ideal (e.g., having only image-level labels for images with many objects). Alternately, the labels may be low-quality, and simply be inaccurate.

One paradigm within weak supervision is active learning. Such algorithms provide a prediction for each sample with a certain confidence level. The samples with the lowest confidence can then be manually tagged by an expert and the algorithm trained again. While this approach reduces the number of samples to be annotated, it is based on human labeling, which is time-consuming.

In transfer learning, a model that has been previously trained on a large and general dataset is used to classify a new dataset. The idea behind this type of model is to use a pre-trained model and to fine tune the algorithm on the new dataset. This approach is much less time-consuming than training a new model, and needs fewer data samples since the model just needs to be fine-tuned. Unfortunately, this method will give accurate predictions only if the initial and new datasets are similar enough.

Semi-supervised learning is a combination of unsupervised and supervised approaches. The method requires a relatively small amount of labeled data and large-scale unlabeled data. The idea is to analyze data distribution of the unlabeled data for clustering, and exploit the information from limited labeled data to classify and fine tune the clusters. Semi-supervised learning can be used in cases in which the labeled data is not complete and generate classification scores. But while the required amount of labeled data is smaller, it may still be significant in order to achieve good results. The success of this approach has a high dependency on the distribution of the labeled data.

Recent work proposes to generate synthetic labels and use them as labels in a supervised model. The synthetic labels are generated using heuristic rules which are derived from domain knowledge. These rules can be applied programmatically to label a large scale of unlabeled data. One such approach is the “Snorkel method,” described at https://arxiv.org/pdf/1711.10160.pdf, which is a framework to apply a set of domain-knowledge-based rules on data in order to generate synthetic labels. In this approach, a “label model” algorithm generates synthetic labels based on a set of deterministic rules, taking into account coverage and correlation of the rules. Then, a supervised model is trained using the synthetic labels that were generated in the previous stage, as well as various features. In general, the synthetic labels are not suitable to use as the final predictions of the model, as in most cases they suffer from low coverage due to the specificity of the rules. Therefore, the supervised model is trained with different features that can be generalized and have high coverage. For example, in text classification problems, the set of rules for the synthetic labels' generation might include: “Does the text contain the word ‘subscription’?”, while the features of the supervised model might be word embedding of the text (a numeric vector that was pre-trained to fit a numeric representation for each word, such that words with similar meaning are closer in the vector space). In cases in which there is access to only a limited amount of real labeled data (even very limited), then the accuracy of the model can still be estimated.

The Snorkel method is suitable for a wide range of problems. Deterministic labeling functions can be generated easily, and the method exploits the benefits of a supervised model, with only slight decrease in performance compared to cases where real labels are available. On the downside, synthetic labels may be inaccurate and noisy, and rules may incorrectly predict labels in some instances. For example, different rules may indicate different labels: decisions from two different heuristics for the same instance might be contradictory, and it might be challenging for the model used for labeling to decide which one should be chosen for the final label.

The approach described in the present disclosure aims to improve on the shortcomings in current weak supervision methods for machine learning that utilize synthetic labels. The proposed solution describes a flow (which may be referred to as Integrated Synthetic Labeling Optimization, or ISLO) that jointly optimizes both a label model and a supervised model in a holistic manner. This approach considers the possible interaction between the two models, unlike prior approaches.

In the present disclosure, label models and supervised models are described as being used in the context of solving a “classification problem.” In machine learning, classification is a process of categorizing a given set of data into classes (which are commonly referred to as being identified with labels). A classification problem refers to a particular setting in which classification is to occur. One example of a classification problem is to recognize emails as spam or non-spam.

As used herein, a “label model” for a classification problem refers to a set of logic or rules that can be applied to unlabeled data. For a given item of unlabeled data, a classification produced by a label model is referred to as a “synthetic label.” The modifier “synthetic” is intended to connote the provisional nature of the label—as will be seen, the disclosed techniques enable multiple sets of synthetic labels produced by different label model/supervised model combinations to be compared against one another in order to determine which model is to be selected. Another possible name for synthetic labels is “proxy labels.”

Generally speaking, a “supervised model” is a machine learning model that uses a set of labeled data as a training set in order to help the model yield the desired output. A supervised model can be implemented by various known algorithms, including neural networks, Naïve Bayes, linear regression, logistic regression, support vector machine (SVM), and K-nearest neighbor. In the present disclosure, supervised models are trained using a data set having synthetic labels as described above. More particularly, a given supervised model may be trained with different sets of synthetic labels, resulting in different fitted models. These models may then be evaluated, including by using a set of labeled data (which may be limited in nature).

The inventors have recognized that attempting to optimize the label model and its corresponding supervised model independently can lead to unsuitable synthetic labels for the supervised model that can lead to a decrease in its performance. Accordingly, the present approach attempts to optimize label models and supervised models in a holistic way—that is, by considering possible interactions between the two models. This integrated flow optimizes a given label model to best fit its corresponding supervised model. Note that, as used herein, the term “optimize” refers to an attempt to improve the performance or functionality, and does not require that some “optimum” performance state be reached. Thus, references to joint optimization of a label model and its corresponding supervised model are to be understood to connote an attempt to improve the overall performance of these models by considering the interactions of these models with one another.

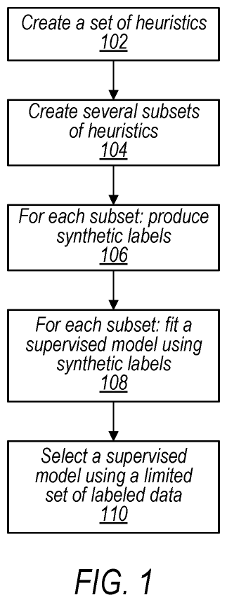

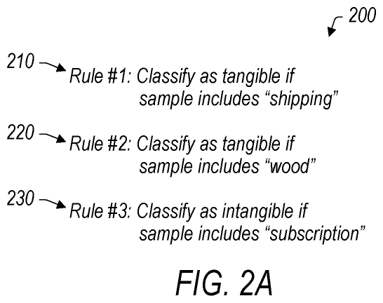

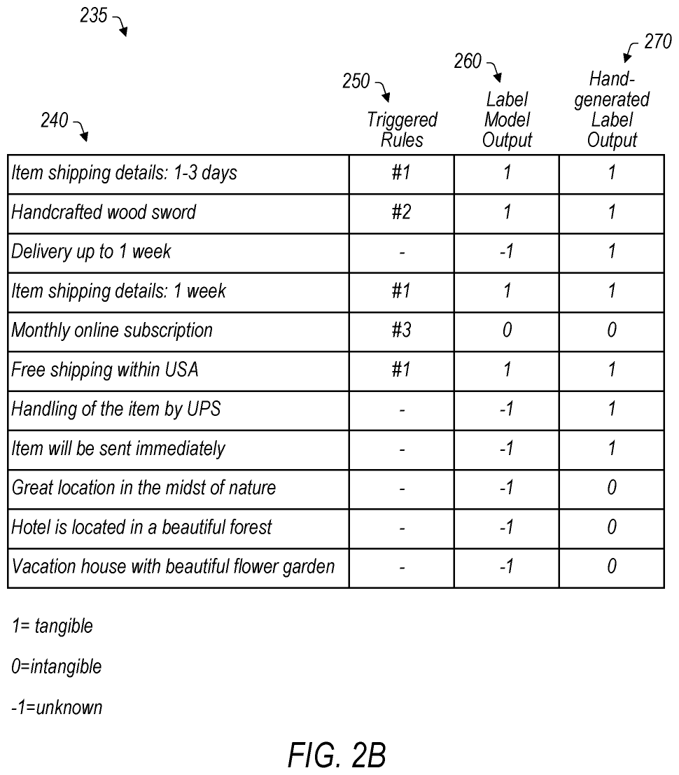

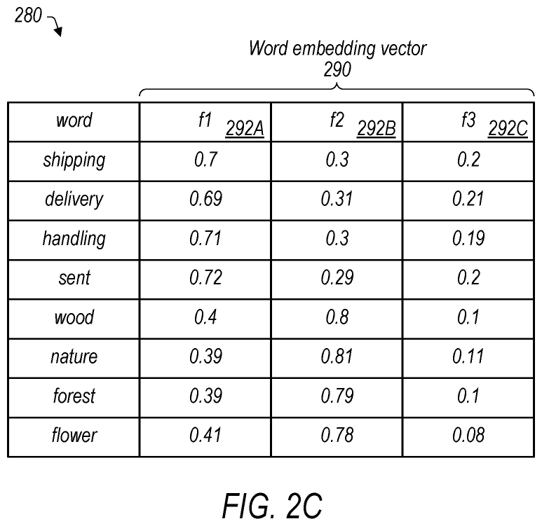

The approach can be briefly summarized as illustrated in FIG. 1, which depicts a method 100. In 110, a set of heuristics is created that defines a rule set for the classification problem. The heuristics are typically created by users based on domain-specific knowledge pertinent to the classification problem. Method 100 is usable with any suitable type of classification problem, including text-based classification problems. An example set of heuristics is described below with respect to FIG. 2A. Several examples of classification problems are also provided below.

Then, in 120, different subsets of the rule set are created. For example, if the rule set in 110 has three rules (1, 2, 3), the different subsets in 120 may be subset 1 (1, 2), subset 2 (2, 3), and subset 3 (1, 3).

In 130, synthetic labels are produced by applying each rule subset to a set of unlabeled data. FIG. 2B shows an example of applying a set of labels generally. Each rule will have an output that maps to one or more labels. For a given classification problem, a rule might produce a “yes” label, a “no” label, or an “unknown” label in some implementations.

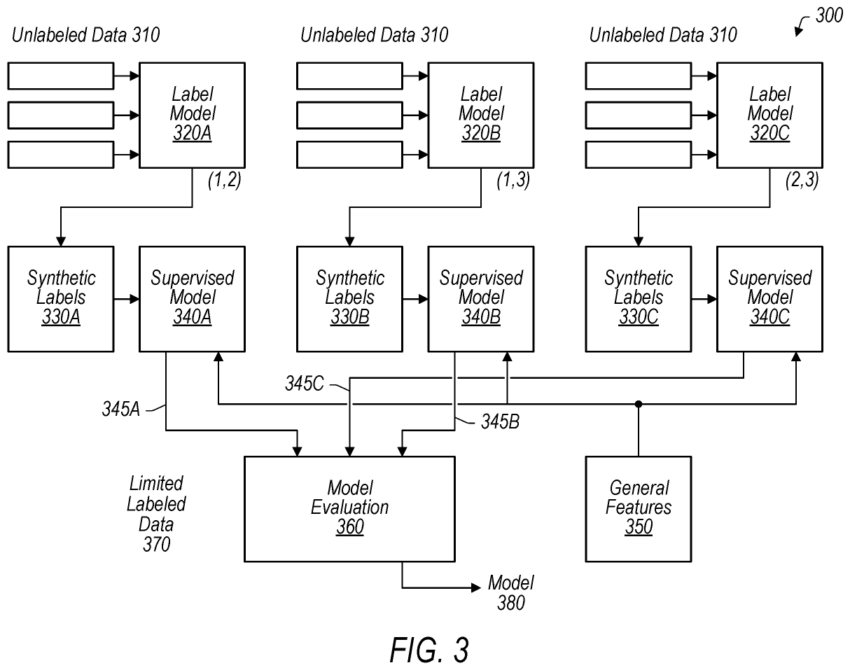

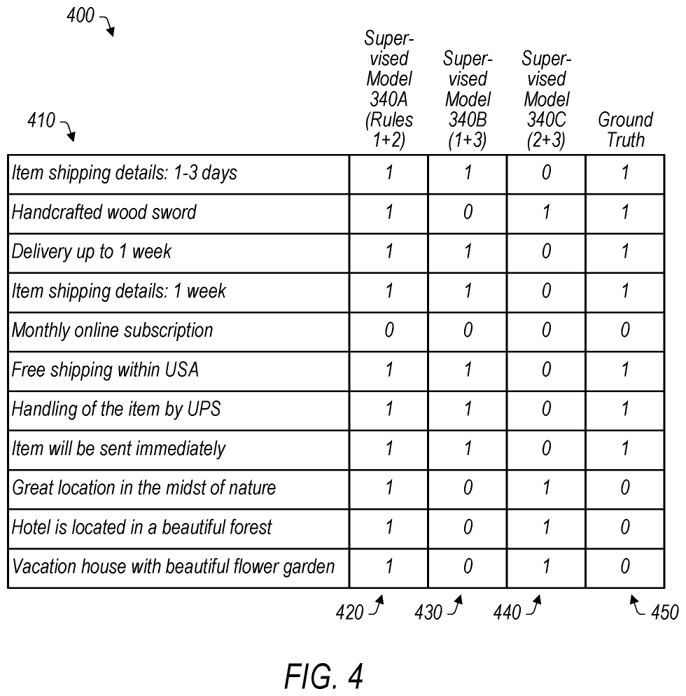

Next, in 140, a supervised model is fit for each subset by using the synthetic labels produced in 130. Model fitting is the process of measuring how well a machine learning model generalizes data similar to that with which it was trained, and then adjusting model parameters in order to improve the fit. A good model fit refers to a model that accurately approximates the output when provided with new inputs. An “underfit” model is one that cannot sufficiently model the training data or generalize new data. An “overfit” model, on the other hand, is one that learns the details and noise in the training data too efficiently. While an overfit model performs well on the training data, it performs poorly when making predictions for new data. In some embodiments, model fitting may include the use of an error function that provides a measurement of a difference between known data and the model's predictions. This measurement might be the sum of squared error (SSE), for example. Once a measurement of error is obtained, one or more model parameters may be adjusted, new predictions generated, and new error measurement obtained, etc., until error is minimized. In general, any known approaches for model fitting are contemplated in 140. Thus, if three sets of synthetic labels are produced (1, 2, and 3), three supervised models are fit: one using synthetic label set 1, one using synthetic label set 2, and one using synthetic label 3. An example of the application of steps 130 and 140 is described below with respect to FIGS. 3 and 4.

In 150, one of the supervised models may be selected. This process may involve using a set of labeled data to evaluate the supervised models that have been fit. Any of various known techniques for evaluating model performance can be used in 150; several possibilities are described below with respect to FIG. 3. Because the set of labeled data is used to evaluate, but not train, the model, method 100 permits weakly supervised machine learning. This approach works well where the size or amount of the set of labeled data is sufficient to help evaluate a supervised model, but not to train it in the first instance. This paradigm can lead to improved machine learning performance in scenarios where there is little or no labeled data.

Turning now to FIG. 2A, consider a sample set of heuristics 200 for a text classification example. The classification problem is detecting whether a transaction involves a “tangible” (as opposed to “intangible”) item based on a description of the item. Tangible items would have a physical instantiation, as opposed to intangible items such as digital subscriptions or services. Rule #1 (identified by reference numeral 210) and Rule #2 (reference numeral 220) classify a product as tangible if the words “shipping” and “wood,” respectively, are in the description. Rule #3 (reference numeral 230) classifies a product as intangible if the word “subscription” is in the description. Obviously, many more rules are possible in a real-world environment, but only three rules are set forth in FIG. 2 for the sake of simplicity.

FIG. 2B depicts table 235, which illustrates the results if a single label model based on these three rules is used to generate labels for text samples of unlabeled data in column 240. Column 250 indicates which of Rules #1-3 is triggered by each sample. Column 260 indicates the output of the label model for each sample: “1” indicates a tangible product, “0” indicates an intangible product, and “−1” indicates unknown. The logic for the label model can be specified by the expression Tangible=Rule #1 OR Rule #2, Intangible=Rule #3, ELSE Unknown.

Column 270 is not part of the unlabeled data. This column indicates actual labels for each sample—that is, the ground truth for these samples. This information is included to facilitate the understanding of the disclosed innovation, thus illustrating that label models are not always 100% accurate. The entries referring to “carriage” of an item and an item being “dispatched” refer to a tangible item, while the entries referring to a property, hotel, or vacation home are categorized as an intangible item.

The bolded terms in column 240 are either those found in heuristics 200 or similar words as measured within a word embedding space described next with respect to FIG. 2C.

Word embedding, in the field of natural language processing (NLP), is a term used for the representation of words to perform analysis of text. This representation is commonly in the form of a vector that encodes the meaning of the word such that words that are closer in the vector space are expected to be similar in meaning. Word embeddings can be obtained, for example, using a set of language modeling and feature learning techniques where words or phrases from the vocabulary are mapped to vectors of real numbers. In many cases, the mathematical embedding is from a space with many dimensions per word to a continuous vector space with a much lower dimension.

FIG. 2C depicts table 280, which includes component values for word embedding vectors 290 for a series of words 285 found in the unlabeled data of column 240 of FIG. 2B. The word embedding space is three-dimensional, as exemplified by the three component values 292A, 292B, and 292C.

Recall that “shipping” is specified in Rule #1 (220). The words that are close to “shipping” in the word embedding space are “delivery,” “handling,” and “sent.” These words have vector values that cluster around the point (0.7, 0.3, 0.2) in the embedding space. Similarly, the word “wood,” which is specified in Rule #2 (230) is close to “nature,” “forest,” and “flower.” These words have vector values that cluster around the point (0.4, 0.8, 0.1).

Suppose a supervised model is trained using the single label model from FIG. 2B as well as the features within the word embedding space. Such training causes the model, when encountering a sample with a word within the embedding space that is close to a word in one of heuristics 200, to make a prediction that is likely to be similar to the label of that heuristic. For example, because “delivery,” “handling,” and “sent” are similar to “shipping” within the embedding space, the supervised model is likely to predict a label of “tangible” (1) for samples with any of these words.

Conversely, because “nature,” “forest,” and “flower” are close to “wood” in the embedding space, the supervised model is likely to predict a label of “tangible” (1) for samples with any of these words. (Recall that the term “wood” triggers Rule #2) But as can be seen from column 270, such predictions would be inaccurate. The inventors have recognized that a paradigm in which a supervised model is trained using labels from all possible heuristics can lead to sub-optimal results.

A block diagram 300 of the proposed solution is shown in FIG. 3. This approach involves the use of multiple label models 320, each of which has a different set of logic. Thus, where the label model described above with respect to FIG. 2B utilized each of the rules #1-3 in the set of heuristics 200, each label model 320 in FIG. 3 utilizes a subset of the rules. For example, label model 320A might be based on Rules #1 and 2 (but not 3), label model 320B might be based on Rules #1 and 3 (but not 2), and label model 320C might be based on Rules #2 and 3 (but not 1). Thus, in some embodiments, each label model might utilize a different subset of a set of rules, which may correspond to domain-specific knowledge pertinent to the classification problem. Any desired number of label models, each having a different set of rules, can be evaluated according to the approach of FIG. 3.

Each label model 320 evaluates a set of unlabeled data 310 to produce a respective set of corresponding synthetic labels 330. Thus, label model 320A produces synthetic labels 330A, label model 320B produces synthetic labels 330B, and label model 320C produces synthetic labels 330C. Then, a supervised model corresponding to each label model is fitted using the synthetic labels produced by that label model and a set of general features 350 (e.g., the word embedding vectors).

Each supervised model 340, once fit, is then used to generate a corresponding set of predictions for a plurality of samples. These samples may include samples 370, for which actual “ground truth” labels are available, as well as portions of unlabeled data 310 for which synthetic labels are unavailable. At this point, each supervised model 340 (and, by extension, its corresponding label model 320) can be evaluated by model evaluation module 360.

There are various known techniques for evaluating a machine learning model. It is common to classify a given prediction into one four categories: true positive, true negative, false positive, and false negative. A true positive is when some property is predicted for a sample, and that prediction is correction. Similarly, a true negative is when the property is not predicted for a sample, and that prediction is correct. A false positive is when the property is incorrectly predicted to be present for a sample (e.g., a product is classified as tangible when it is in fact intangible), while a false negative is incorrectly predicted to not be present for a sample (e.g., a product is classified as intangible when it is in fact tangible). These results may be plotted on a confusion matrix. Those items predicted to be positive—that is, the true positives and the false positives—are sometimes referred to as the “selected elements.” The items that are actually positive—that is, the true positives and the false negatives—are sometimes referred to as the “relevant elements.”

Common metrics used to evaluate a classification model are accuracy, precision, and recall. Accuracy is the percentage of correct predictions for the test data. It can be calculated by dividing the number of correct predictions by the total number of predictions. Precision can be defined as the number of true positives divided by the number of the selected elements. Recall, on the other hand, can be defined as the number of true positives divided by the number of relevant elements. Another important evaluation technique is referred to as area under the curve, or AUC. This technique uses the area under the receiving operating characteristics (ROC) curve to evaluate classification model performance. The curve is created by plotting the true-positive rate against the false-positive rate. The model performance is measured by this curve, and it helps understand how a model performs across different threshold values for classifying data points as positives or negatives. This curve can be used to describe the performance of a classifier when faced with ROC space, which is a two-dimensional plane created by plotting True Positive Rate (TPR) and False Positive Rate (FPR). In some cases, the AUC value ranges from 0.50 to 0.70 for random classification while it rises to 0.95 if classification is perfect (i.e., all true positives and no false negatives). A/B testing is another known machine learning model evaluation technique.

Whatever performance metrics are used to evaluate predictions 345, model evaluation module 360 is operable to select at least model 380 for further use. Model 380 is indicative of one of supervised models 340, and by extension, the corresponding label model 320. The selected model can thus be used going forward for future classification needs. For example, the selected label/supervised model may serve as a model in a production version of a software application.

FIG. 4 depicts table 400, which includes sample predictions for each of the supervised models 340 illustrated in FIG. 3, relative to the text samples found in column 410 (which are identical to the text samples previously in column 240 of table 235 depicted in FIG. 2B As noted, supervised models 340 utilize different subsets of a set of rules: Rules #1 and 2 (340A), Rules #1 and 3 (340B), and Rules #2 and 3 (340C). Table 400 includes the predictions for these models in columns 420, 430, and 440, respectively. Table 400 also includes column 450, which includes the hand-generated, “ground truth” labels for the samples in column 410. (These values are the same as those found in column 270 of FIG. 2B.)

A comparison of columns 420 and 450 reveals that supervised model 340A performs reasonably well, with one notable exception. Due to the inclusion of Rule #2, model 340A (correctly) predicts “handcrafted wood sword” as a tangible item. But because of the closeness of “nature,” “forest,” and “flower” to “wood” in the embedding space, this model incorrectly predicts the last three samples in column 410. In this hypothetical, these samples are descriptions of an intangible product (a hotel stay/service), where “nature,” “forest,” and “flower” describe the surroundings of the property where the stay is to occur. Accordingly, the inclusion of Rule #2 leads to reduced prediction performance.

The subset of Rules #2 and 3 used for supervised model 340C (column 440) leads to even worse performance than model 340A. The exclusion of Rule #1 (which focuses on the term “shipping” and similar terms) results in only two out of eleven samples in column 410 being predicted correctly by model 340C. These results make clear that the inclusion of Rule #1 is important to the performance of model 340.

The results of supervised model 340B, which is based on Rules #1 and 3, are found in column 430. In one possible of fitting, this model predicts all but one sample correctly. Accordingly, the exclusion of Rule #2 results in a better-performing model 340. While the inclusion of Rule #2 would allow the “handcrafted wood sword” sample to be predicted correctly, this rule, due to the closeness of “wood” to “nature,” “forest,” and “flower” in the word embedding space, would also cause numerous text samples relating to an intangible product to be incorrectly predicted as being tangible.

FIG. 4 thus illustrates how the multiple model approach of FIG. 3 can avoid the previously discussed downsides of the single model approach. The approach of FIG. 3 suggests an Integrated Synthetic Labeling Optimization (ISLO) flow that optimizes the label and supervised models in a holistic way, considering the possible interaction between the two steps. As opposed to an approach in which the label model and the supervised are independently optimized, the proposed approach recognizes that the label model affects the supervised model as the latter uses the synthetic labels that the former generates. As noted, the inventors have recognized that optimizing each model independently may lead to unsuitable labels for the supervised model, which can in turn lead to a decrease in the supervised model's performance. In other words, an integrated flow can benefit from optimizing the label model to best fit the supervised model.

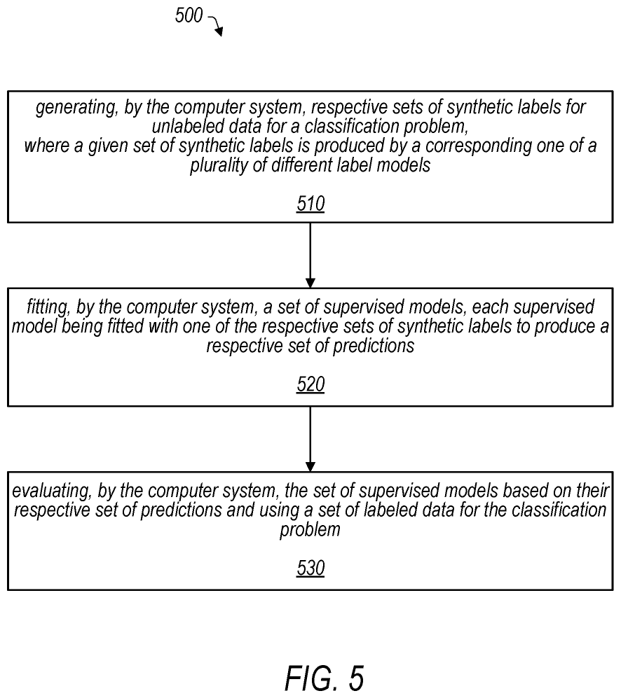

FIG. 5 is a flow diagram of one embodiment of a computer-implemented method 500 for facilitating machine learning.

Method 500 begins in 510, in which a computer system generates respective sets of synthetic labels for unlabeled data for a classification problem. A given one of the respective sets of synthetic labels is produced by a corresponding one of a plurality of different label models. For example, if the plurality of different label models includes label models label_model_{A}, label_model_{B}, and label_model_{C}, the respective sets of synthetic labels might be referred to as synthetic_labels_{A}, synthetic_labels_{B}, and synthetic_labels_{C}, where synthetic_labels_{A} is produced by label_model_{A}, and so on. The different label models have rule sets that differ in some respect. In some cases, each label model utilizes different subsets of a set of rules. For example, if a set of rules includes rules A, B, and C, label_model_{A} might be based on rules A and B but not C, label_model_{B} might be based on rules B and C but not A, and label_model_{C} might be based on rules A and C but not B.

In 520, method 500 continues, with the computer system fitting a set of supervised models. A given one of the set of supervised models is fitted with one of the respective sets of synthetic labels, producing a respective set of predictions. Continuing with the example above, consider a set of supervised models that includes supervised_model_{A}, supervised_model_{B}, and supervised_model_{C}. The supervised_model_{A} is fitted using synthetic_labels_{A}, producing a set of predictions called predictions_{A}. In some cases, each supervised model is also fitted using a set of general features, such as specified values for a word embedding vector.

Next, in 530, the computer system evaluates the set of supervised models based on their respective sets of predictions and using a set of labeled data for the classification model. The evaluation may be performed in numerous ways using different types of criteria. For example, supervised_model_{A}, supervised_model_{B}, and supervised_model_{C}, can each be supplied a set of labeled data, and then predictions_{A}, predictions_{B}, and predictions_{C} can all be evaluated using the set of labeled data. The correspondence of a given set of predictions for a supervised model can then be compared to the ground truth labels known from the label data. The supervised model with the highest score or conformance with the ground truth labels can then be selected for use going forward if desired. The method may thus include, in some embodiments, selecting, by the computer system, at least one of the set of supervised models based on the evaluating.

In some cases, the classification problem is a text-classification problem (e.g., sentiment analysis). In some cases, method 500 may be employed in scenarios in which a size (i.e., a number of samples) of the set of labeled data is sufficient to evaluate, but not train, the set of supervised models. Method 500 may thus allow machine learning to still obtain useful results, even where there is only a small quantity of labeled data for a particular classification problem.

Method 500 can be implemented by program instructions stored on a non-transitory computer-readable storage medium that are capable of being executed by a computer system. Similarly, a computer system that implements method 500 is also contemplated.

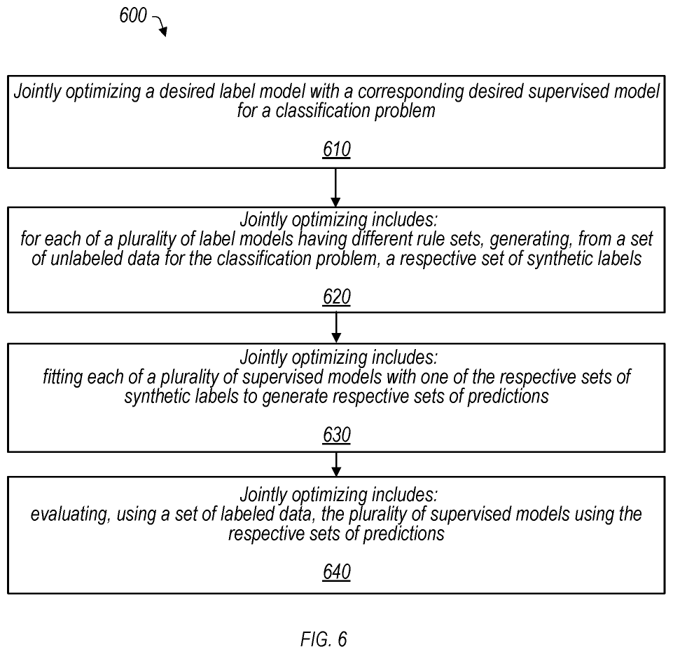

FIG. 6 is a flow diagram of one embodiment of a computer-implemented method 600 for facilitating machine learning. Method 600 includes 610, in which a computer system jointly optimizes a desired label model and a corresponding desired supervised model for a classification problem. In some embodiments, the classification problem is a text-classification problem.

Step 610 includes several sub-steps, including 620, in which a respective set of synthetic labels are generated for each of a plurality of label models, where the label models each have different rules sets. The sets of synthetic labels are generated from a set of unlabeled data for the classification problem. In some embodiments, the different rule sets are different subsets of a plurality of domain-specific heuristics for the classification problem.

Step 610 also includes sub-step 630, in which each of a plurality of supervised models is fitted with one of the respective sets of synthetic labels to generate respective sets of predictions. In some embodiments, each of the plurality of supervised models is also fitted using a set of general features. One example of these features is a set of vector values for terms in a word embedding space.

In sub-step 640 of step 610 the models in the plurality of supervised models are evaluated, using a set of labeled data and the respective sets of predictions. Thus, ground truth for the labeled samples can be compared to the various sets of predictions. As has been noted, in some instantiations, the size of the set of labeled data may be sufficient to evaluate the respective sets of predictions of the plurality of supervised models, but is insufficient to train the plurality of supervised models. The evaluation can take various forms, based on precision, accuracy, etc., and can be performed according to a whatever scoring methodology is desired. The evaluation can be used to select a particular label model and the corresponding particular supervised model from the plurality of label models and the plurality of supervised models. Accordingly, if supervised_model_{B} is determined by the evaluation process to produce the best results, then supervised_model_{B} and label_model_{B} can be selected for use with the classification problem going forward. Accordingly, in some embodiments, method 600 further includes utilizing the particular supervised model to evaluate the classification problem for subsequently generated data samples.

Method 600 can be implemented by program instructions stored on a non-transitory computer-readable storage medium that are capable of being executed by a computer system. Similarly, a computer system that implements method 600 is also contemplated.

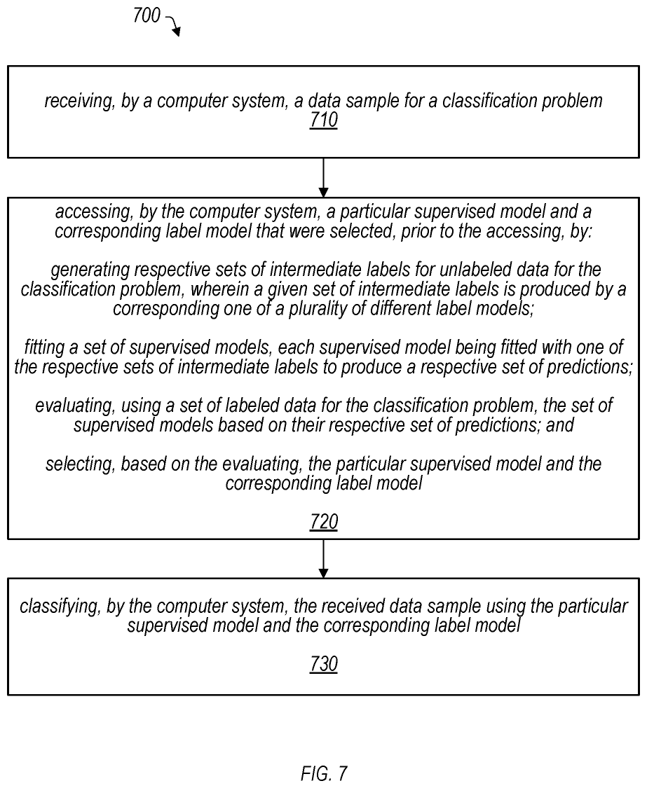

FIG. 7 is a flow diagram of one embodiment of a computer-implemented method 700 for utilizing a trained machine learning model. Method 700 begins in 710, in which a computer system receives a data sample for a classification problem, which may be a text-classification problem. In 720, a particular supervised model and a corresponding label are accessed by the computer system. In 730, the computer system classifies the received data sample using the particular supervised model and the corresponding label model.

The particular supervised model and the corresponding label model have been selected, prior to the accessing by a method that includes, a number of steps. First, respective sets of intermediate labels for unlabeled data for the classification problem are generated. (A given set of intermediate labels is produced by a corresponding one of a plurality of different label models.) Second, each of the set of supervised models is fitted with one of the respective sets of intermediate labels to produce a respective set of predictions. Next, the set of supervised models are evaluated using a set of labeled data for the classification problem, the set of supervised models and based on their respective set of predictions. Finally, the particular supervised model and the corresponding label model are selected based on the evaluating.

Method 700 can be implemented by program instructions stored on a non-transitory computer-readable storage medium that are capable of being executed by a computer system. Similarly, a computer system that implements method 700 is also contemplated.

The techniques disclosed herein are applicable to many different types of classification problems. A few examples are provided below in order to demonstrate the range of possible different applications.

For example, the proposed paradigm could be used in a healthcare setting to detecting patients suffering from a certain condition using Electronic Health Records (EHRs). In this scenario, the heuristics are defined by clinicians, such as those that can be derived from the medical history. Sample heuristics include “did the patient have a heart attack in the past 10 years?,” “is the patient taking drugs?,” etc. The label model can create synthetic labels from this set of rules. Then the supervised model would exploit the synthetic tag with a set of generic features derived from the EHR (results of medical tests, free text written by clinicians etc.).

Another possible application of the disclosed techniques is to decide the sentiment of a text sample. For example, with respect to a particular product or service, text may have a neutral, positive, or negative sentiment. Here, the set of rules would be defined as a set of words which are known to be associated with the specific sentiment with high precision and relatively low coverage. For example, the term “brilliant” is associated with a positive sentiment. The label model will create synthetic labels based on these rules. Then the supervised model will use this synthetic labeling together with features extracted from the free text itself.

The disclosed techniques can also be used to identify malicious websites. In this situation, the tags are words which are known to be associated with forbidden websites and which can be found in the HTML text. The supervised model can then use these tags together with features derived from the full HTML text and technical information about the website such as technology used.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

In general, any of the services or functionalities of a machine learning environment described in this disclosure can be performed by a computer system/computing device. A given computing device can be configured according to any known configuration of computer hardware. A typical hardware configuration includes a processor subsystem, memory, and one or more I/O devices coupled via an interconnect. A given computing device may also be implemented as two or more computer systems operating together.

The processor subsystem of the computing device may include one or more processors or processing units. In some embodiments of the computing device, multiple instances of a processor subsystem may be coupled to the system interconnect. The processor subsystem (or each processor unit within a processor subsystem) may contain any of various processor features known in the art, such as a cache, hardware accelerator, etc.

The system memory of the computing device is usable to store program instructions executable by the processor subsystem to cause the computing device to perform various operations described herein. The system memory may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read-only memory (PROM, EEPROM, etc.), and so on. Memory in the computing device is not limited to primary storage. Rather, the computing device may also include other forms of storage such as cache memory in the processor subsystem and secondary storage in the I/O devices (e.g., a hard drive, storage array, etc.). In some embodiments, these other forms of storage may also store program instructions executable by the processor subsystem.

The interconnect of the computing device may connect the processor subsystem and memory with various I/O devices. One possible I/O interface is a bridge chip (e.g., Southbridge) from a front-side to one or more back-side buses. Examples of I/O devices include storage devices (hard drive, optical drive, removable flash drive, storage array, SAN, or their associated controller), network interface devices (e.g., to a computer network), or other devices (e.g., graphics, user interface devices.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
generating, by a computer system, respective sets of synthetic labels for unlabeled data for a classification problem, wherein a given one of the respective sets of synthetic labels is produced by a corresponding one of a plurality of different label models;
fitting, by the computer system, a set of supervised models, a given one of the set of supervised models being fitted with one of the respective sets of synthetic labels to produce a respective set of predictions; and
evaluating, by the computer system, the set of supervised models based on their respective set of predictions and using a set of labeled data for the classification problem.

2. The method of claim 1, wherein the classification problem is a text-classification problem.

3. The method of claim 2, wherein each supervised model is also fitted using a set of general features.

4. The method of claim 3, wherein the set of general features specifies values for a word embedding vector.

5. The method of claim 2, wherein the text-classification problem is sentiment analysis.

6. The method of claim 1, wherein the different label models utilize different subsets of a set of rules.

7. The method of claim 1, wherein the evaluating includes evaluating the respective set of predictions according to the set of labeled data.

8. The method of claim 1, further comprising selecting, by the computer system, at least one of the set of supervised models based on the evaluating.

9. The method of claim 1, wherein the classification problem is a text-classification problem, and wherein a size of the set of labeled data is sufficient to evaluate, but not train, the set of supervised models.

10. The method of claim 9, wherein the different label models utilize different subsets of a set of rules.

11. The method of claim 10, wherein the evaluating includes evaluating the respective set of predictions according to the set of labeled data.

12. A non-transitory computer-readable medium having instructions stored thereon that are executable by a computer system to perform operations for weakly supervised machine learning, the operations comprising:
jointly optimizing a desired label model and a corresponding desired supervised model for a classification problem, wherein the jointly optimizing includes:
for each of a plurality of label models having different rule sets, generating, from a set of unlabeled data for the classification problem, a respective set of synthetic labels;
fitting each of a plurality of supervised models with one of the respective sets of synthetic labels to generate respective sets of predictions; and
evaluating, using a set of labeled data, the plurality of supervised models using the respective sets of predictions; and
wherein the evaluating is usable to select a particular label model and the corresponding particular supervised model from the plurality of label models and the plurality of supervised models.

13. The computer-readable medium of claim 12, wherein the different rule sets are different subsets of a plurality of domain-specific heuristics for the classification problem.

14. The computer-readable medium of claim 12, wherein the classification problem is a text-classification problem, and wherein each of the plurality of supervised models is also fitted using a set of vector values for terms in a word embedding space.

15. The computer-readable medium of claim 12, wherein the classification problem is a text-classification problem, wherein a size of the set of labeled data is sufficient to evaluate the respective sets of predictions of the plurality of supervised models, but is insufficient to train the plurality of supervised models.

16. The computer-readable medium of claim 12, wherein the operations further comprise:
utilizing the particular supervised model to evaluate the classification problem for subsequently generated data samples.

17. A method, comprising:
receiving, by a computer system, a data sample for a classification problem;
accessing, by the computer system, a particular supervised model and a corresponding label model that were selected, prior to the accessing, by:
generating respective sets of intermediate labels for unlabeled data for the classification problem, wherein a given set of intermediate labels is produced by a corresponding one of a plurality of different label models;
fitting a set of supervised models, each supervised model being fitted with one of the respective sets of intermediate labels to produce a respective set of predictions; and
evaluating, using a set of labeled data for the classification problem, the set of supervised models based on their respective set of predictions; and
selecting, based on the evaluating, the particular supervised model and the corresponding label model; and
classifying, by the computer system, the received data sample using the particular supervised model and the corresponding label model.

18. The method of claim 17, wherein the classification problem is a text-classification problem, and wherein each of the set of supervised models are also fitted using a set of general features.

19. The method of claim 18, wherein the set of general features specifies values for a word embedding vector.

20. The method of claim 17, wherein the classification problem is a text-classification problem, and wherein a size of the set of labeled data is sufficient to evaluate, but not train, the set of supervised models.
